(19) United States
(12) Patent Application Publication
(10) Pub. No.: US 2005/0223396 A1
(43) Pub. Date: Oct. 6, 2005

(54) Gate construction of a slot-in format type disk device

(75) Inventors: Kouji Azai, Takefu-city (JP); Masahide Moroishi, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/091,531

(22) Filed: Mar. 29, 2005

(30) Foreign Application Priority Data
Mar. 30, 2004 (JP) 2004-100464

(51) Int. Cl. G11B 7/00

(52) U.S. Cl. 720/601

(57) ABSTRACT

Since the gate construction in a disk device having slot-in format is a single layer of felt in which a single article slit is formed, but the disk maintenance force is weak, and variable.

The objective is to provide, on the gate 2 of the disk device 3, a 1st elastic felt 6 on which is formed a single article slit 4 and multiple intersecting slits 5, and a 2nd felt 7 which is fixedly adhered to the rear surface of the 1st felt 6, the elasticity of which is weaker than that of the 1st felt 6. A surface sheet 9 on which is formed a disk transmitting aperture 8 may be also fixedly adhered to the front surface of the 1st felt 6. In order to adjust the hardness by weakening the elasticity of the 2nd felt 7, on the 2nd felt 7, a greater number of intersecting slits 5 may be formed than are existence on the 1st felt 6. In addition, multiple cutouts 10 may also be formed on the single article slit 4 of the 2nd felt 7. In addition, the fore and aft thickness of the 2nd felt 7 may be made to be thinner than that of the 1st felt 6.

The present application is based on and claims priority of Japanese patent application No. 2004-100464 filed on Mar. 30, 2004, the entire contents of which are hereby incorporated by reference.

### BACKGROUND OF THE INVENTION

1. Field of the Invention

The present invention relates to the gate construction of a disk device having a slot-in format wherein, in addition to preventing the penetration of dirt or dust, it is able to support the disk.

2 Description of the Related Art

Conventionally, gate construction in a disk device provided with a slot-in mechanism which transports in or transports out disks such as a DVD and the like is formed from a felt of a single construction in which, for example, as shown by the floating slot 2 of a player 1 such as that shown in the drawing of FIG. 2 of the disc player of Japanese Laid Open Patent Publication S63-298761, formation is accomplished of a single article slit (the “slit” comprising the cut-out through which the object is passed) for transmitting a disk. In addition, as shown by the gate cover 138, shown in the drawing of FIG. 9A of the “recording/reproducing device” described in Japanese Laid Open Patent Publication 2002-334499, formed from the felt of a single construction in which are formed a mask aperture 140, multiple intersecting cut-out apertures 144 and slit 145 (the “slit” comprising the insertion of a surface cut-out).

In gate construction in which insertion and extraction is accomplished of a disk in a disk device provided with a slot-in mechanism, and the function is sought to prevent, for example the penetration of dust to within the disk device, and the penetration of dirt adhering to the disk to within the disk device at the time of inserting the disk, up to the point in which the user manually inserts the disk into the slot in mechanism to the position where it reaches to the gate, and to the position at which the user manually withdraws the disk from the slot in mechanism until it is completely withdrawn. Up to that time the disk is prevented from moving, and the gate is prevented from being withdrawn and dropping down, while maintaining the disk in position. The slit for the article of an ordinary means is closed on both sides, and by inserting a disk, the slit is pushed open from opposing directions, at which time the disk is interposed between both sides while maintaining its elastic restorative force.

Patent Publication 1:
Japanese Laid Open Patent Publication S63-298761

Patent Publication 2:
Japanese Laid Open Patent Publication 2002-334499

### SUMMARY OF THE INVENTION

The gate construction in a disk device having the conventional slot in format referred to above, notwithstanding there being the unanticipated function of maintaining the disk, since in constructing a single felt sheet there is weak force for maintaining the disk, and since there is some variation in the strength and weakness of the elasticity of the felt itself, the disk maintenance force has been unstable. Since the force for maintaining the disk has been unstably weak, it has not been possible to continuously hold the disk in a specified position, and there are cases in which the disk has slipped from the specified position or cases in which the supporting force has succumbed to the force of gravity and the disk has fallen down. The particular problem of weak supporting force, in most cases has occurred with the vertical type disk which more easily receives the influence of gravity than one in the horizontal position.

Both the gate construction of Japanese Laid Open Patent Publication SHO 63-298761 and Japanese Laid Open Patent Publication 2002-334499 have in common, the conventional problems referred to above. Since there is single felt construction, the disk maintenance force is weak, and unstable. In the case of Japanese Laid Open Patent Publication S63-298761, even before and after the disk device slot in mechanism transports the disk, there is the problem that the disk maintenance force is weak. In the case of Japanese Laid Open Patent Publication 2002-334499, there is the problem that the disk maintenance force is ordinarily weak prior to transporting the disk by the disk slot in the mechanism, and that the disk maintenance force for inserting the disk becomes even weaker after the disk is transported.

Concerning the disk maintenance force in the gate construction, attention must be given to yet another point, namely that of felt hardness. Ideally, the felt must have strong elasticity, and should not be too hard. If it is too hard, at the time that the disk makes an insertion or withdrawal to or from the single article slit there is a problem that too great a resistance is produced, particularly at the time of insertion. If the elasticity is made to be too strong, it becomes hard, and if the elasticity is too weak, there is a tendency towards increased softness. Conventionally excessive hardness has been avoided, and there is a sacrifice of elastic hardness, namely disk maintenance force. This presents a great dilemma in terms of increasing the maintenance force of the disk.

In terms of blocking the entry of dust or dirt adhering to a disk, since there is only a single layer of felt, there is concern that the penetration of dust or dirt cannot be prevented.

The present invention has as its objective to provide gate construction in a slot in disk device which, in order to resolve problems associated with the prior art, realizes a felt having strong elasticity, and appropriate hardness, and superior disk maintenance force.

In order to resolve the problems associated with conventional gate construction, the gate construction in the slot in format disk device of the present invention relating to Claim 1 is characterized by the fact that, in a disk device which has a gate for insertion of a disk to and withdrawal of a disk from a device, it is provided with a 1st elastic felt formed both a single article slit and multiple intersecting slits; and a 2nd felt which is fixedly adhered to the rear surface of the 1st felt, on which is formed a single article slit, the elasticity of the 2nd felt at a minimum being weaker than that of the 1st felt.

In addition, the gate construction in the slot in format device of the invention relating to Claim 2 is characterized by the fact that, in a disk device provided with a gate which inserts and withdraws a disk to within and from a device, it is provided with a surface sheet in which a disk transmitting aperture is formed in the gate, and a 1st elastic felt which is fixedly adhered to the rear surface of a surface sheet on which is formed a single article slit and multiple intersecting slits; and a 2nd felt which is assuredly adhered to the rear surface of the 1st felt on which is formed a single article slit, the elasticity of the 2nd slit being weaker than the 1st felt.

In addition, the gate construction in the disk device of the invention relating to Claim 3 is characterized by the fact that, in the invention recorded in Claim 1 and Claim 2, a greater number of intersecting slits are formed in the 2nd felt than in the 1st felt.

In addition, the gate construction in the disk device of the invention relating to Claim 4 is characterized by the fact that, in the invention recorded in Claims 1, 2, and 3, multiple cutouts are formed in the single article slit of the 2nd felt.

In addition, the gate construction in the disk device of the invention relating to Claim 5 is characterized by the fact that, in the invention recorded in Claims 1,2, 3, and 4, the thickness to the front and rear of the 2nd felt is thinner than it is in the 1st felt.

According to the present invention, by adding the 2nd felt to the 1st felt, superior disk maintenance force can be realized with strong elasticity and appropriate hardness. By making the felt to be a double layer, the elasticity can be strengthened overall, and the disk maintenance force can also be strengthened. Since the disk maintenance force is strong, slippage or dropping of the disk can be prevented. Even with a vertical disk device in which the influence of gravity is large, the disk can be assuredly maintained, and prevented from dropping. By making the felt to be a double thickness, variation, elasticity and hardness can be eliminated. By making a 2nd felt which has elasticity which is weaker than that of an elastic 1st felt, excessive hardness can be prevented. It is possible to use a conventional felt in the 1st felt, and by adding a 2nd felt, the disk maintenance force can be adjusted. By means of the double layer felt construction of the 1st felt and the 2nd felt, double weighted dust prevention construction can be achieved, and the function of preventing the entry of dust in the air or of dirt adhering to the disk can be strengthened. In addition, even if a cut-out is formed in the 2nd felt, since the 1st felt is close to the outside, there is no loss of dust prevention.

According to the invention recorded in Claim 2, by means of a surface sheet, protection can be provided against staining or against the loss of the felt.

According to the invention recorded in Claim 3, 4 and 5, it is possible to adjust the elasticity or hardness of the 2nd felt, realizing superior disk maintenance with strong elasticity and appropriate hardness.

### BRIEF DESCRIPTION OF THE DRAWINGS

FIG. 1 is an explanatory diagram of the gate construction relating to the present invention.

FIG. 2 is an explanatory diagram of the gate construction relating to the present invention.

FIG. 3 is an explanatory diagram of the gate construction relating to the present invention.

FIG. 4 is a rear surface diagram of a surface sheet.

FIG. 5 is a front surface diagram of a fixedly adhered surface sheet, a 1st felt and a 2nd felt.

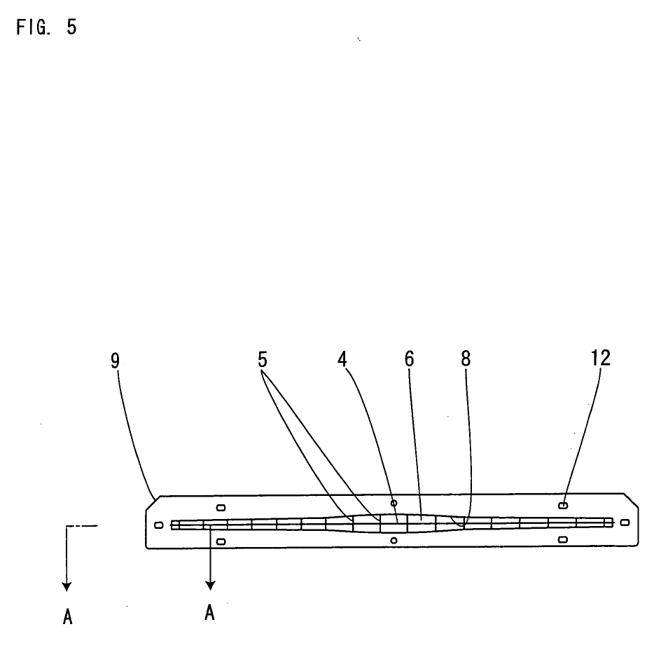

FIG. 6 is an enlarged cross-sectional diagram of the line A-A shown in FIG. 5.

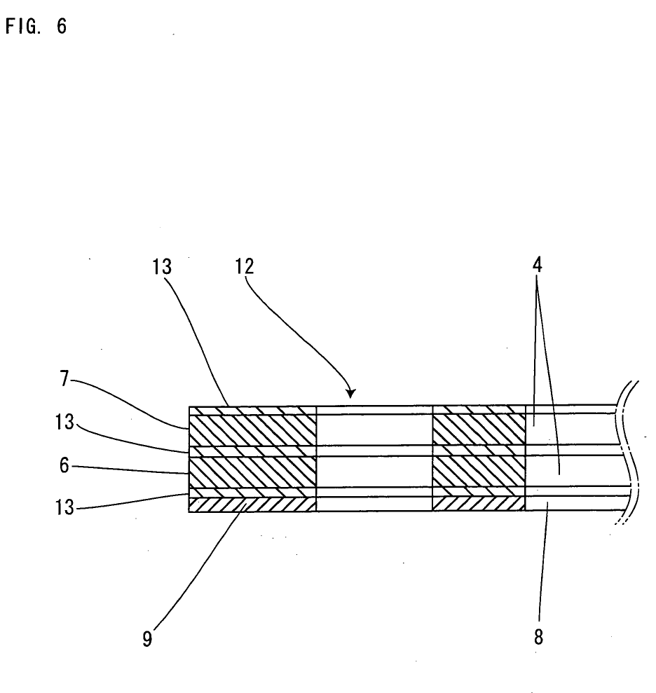

FIG. 7 is a rear surface diagram of a fixedly adhered surface sheet, a 1st felt and a 2nd felt.

FIG. 8 is a plane surface diagram of a fixedly adhered surface sheet, a 1st felt and a 2nd felt.

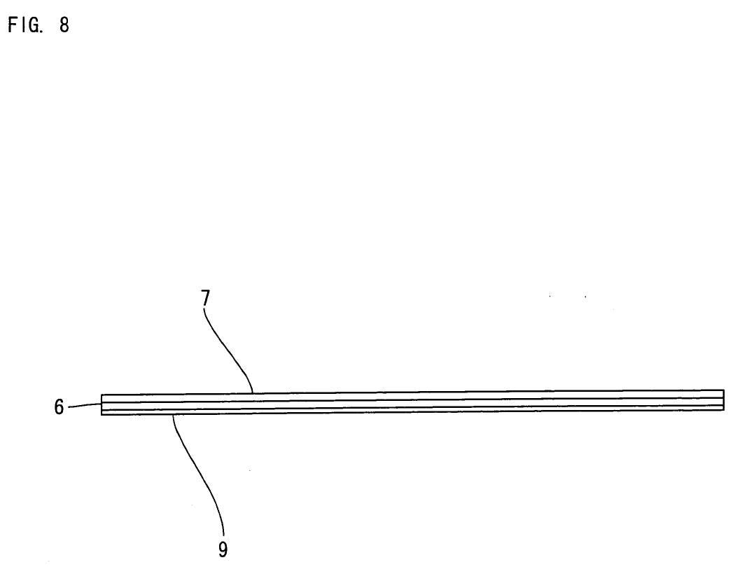

FIG. 9 is a front surface diagram of a fixedly adhered surface sheet, a 1st felt, a 2nd felt and a gate member.

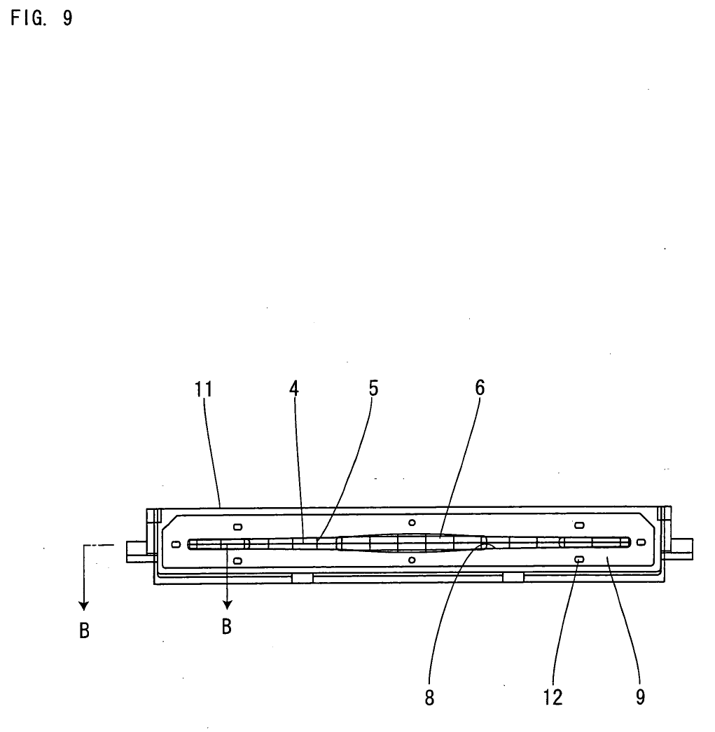

FIG. 10 is an enlarged cross-sectional diagram of the line B-B shown in FIG. 9.

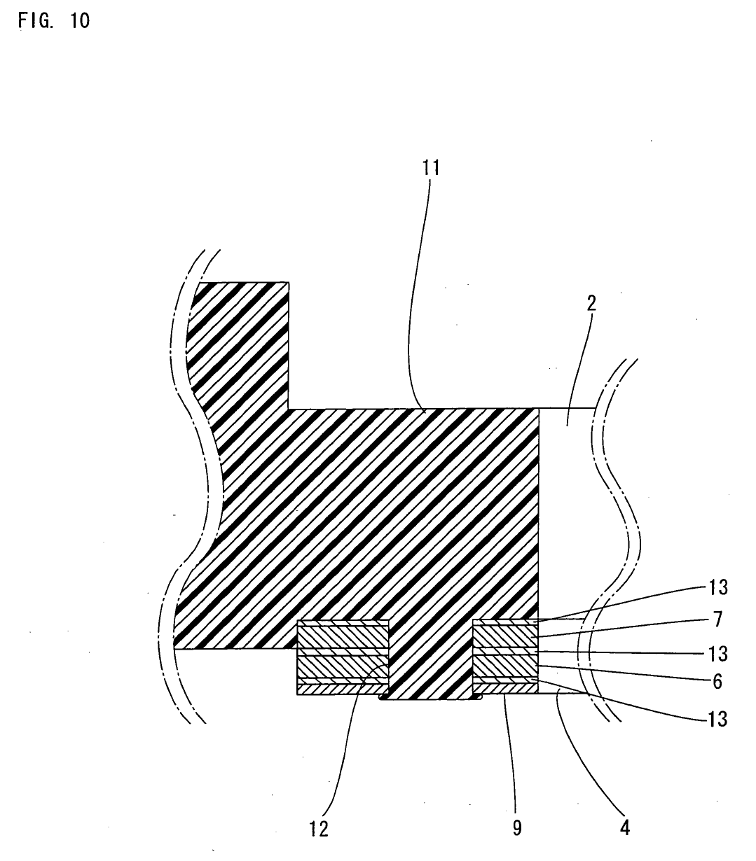

FIG. 11 is an oblique surface diagram of a fixedly adhered surface sheet, a 1st felt, a 2nd felt, and a gate member.

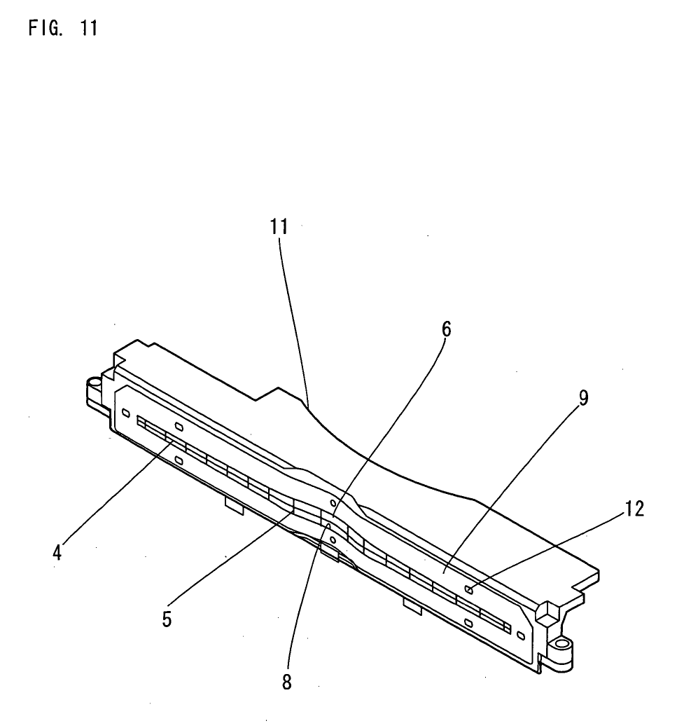

FIG. 12 is an oblique diagram which manifests a disk device.

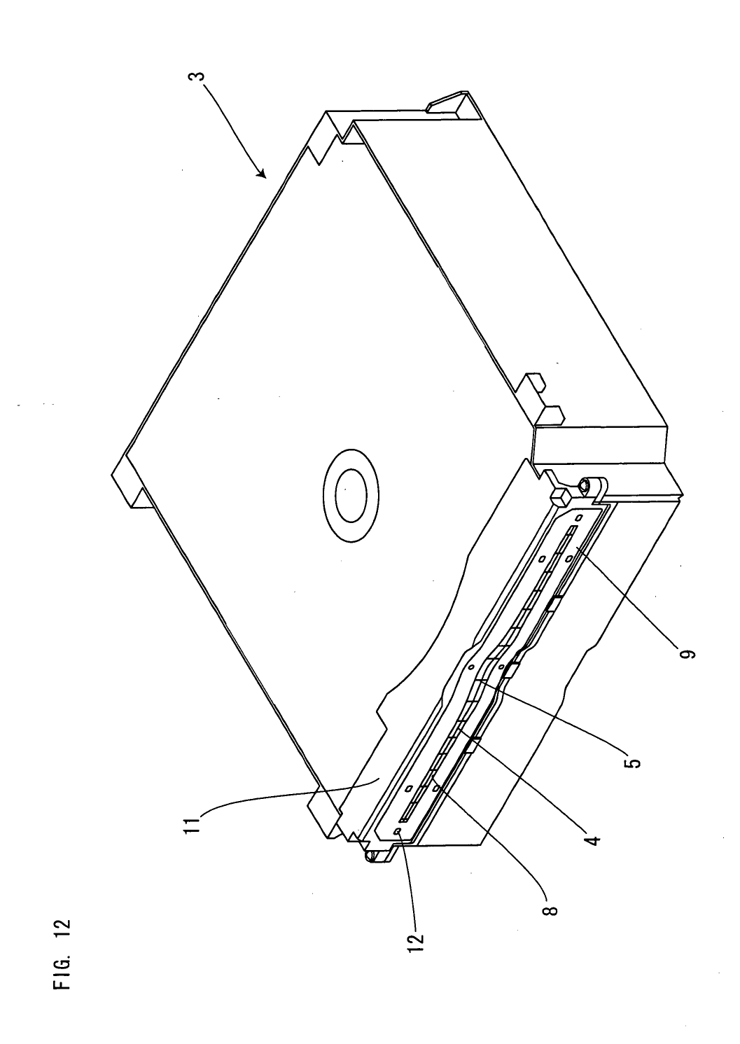

FIG. 13 is an oblique diagram which manifests the state in which a disk in a vertical disk device is supported.

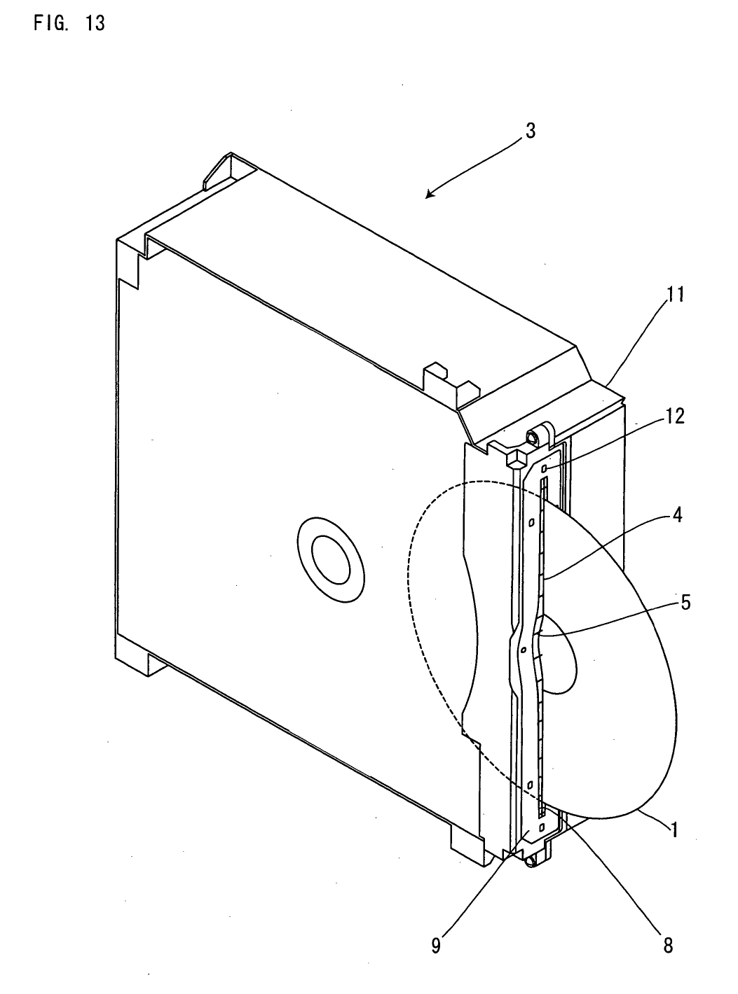

FIG. 14 is an ls comprising an explanatory diagram which manifests the state immediately prior to the manual insertion or immediately following the withdrawal of the disk by a user.

FIG. 15 is an explanatory diagram which manifests the state in which a disk is supported in the carry-in position of the insertion slot/mechanism.

FIG. 16 is an explanatory diagram which manifests the state in which a disk is supported in the withdrawal position.

### DETAILED DESCRIPTION OF THE PREFERRED EMBODIMENTS

An explanation is provided hereafter of a preferred Embodiment for executing the gate construction of the disk device relating to the present invention, with reference to the drawings. However, the present invention is not restricted to only the use of this Embodiment.

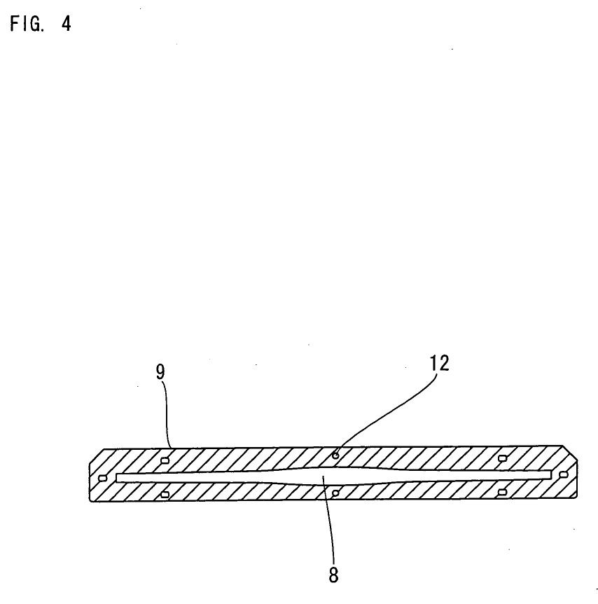

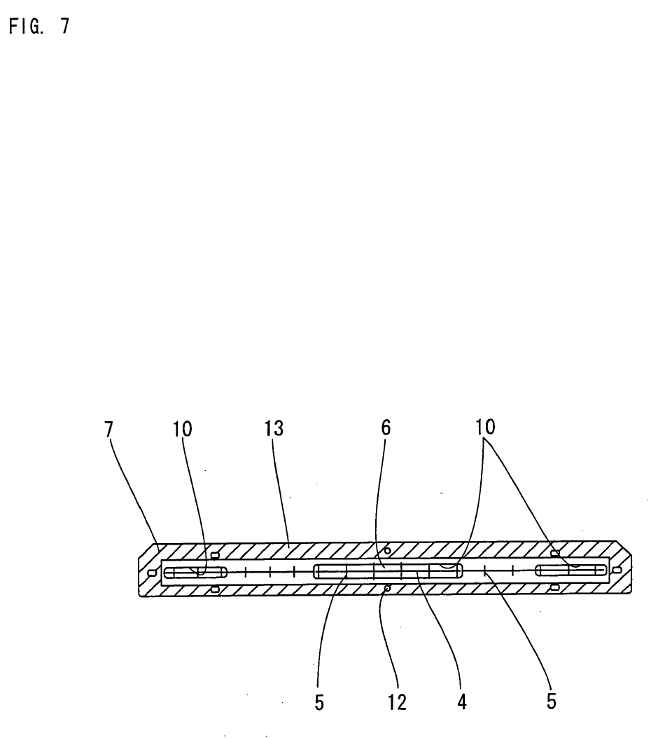

In the figure, 3 represents a disk device which internally houses a slot in mechanism, not shown in the drawing, and 11 represents a gate member in which a gate 2 is formed for inserting a disk to and withdrawing it from the disk device 3. The center of the gate member 11 is bent is to facilitate the insertion of the disk 1. In the figure, 6 represents an elastic 1st felt, in which a single article slit 4 is formed with a penetrating cut in the lengthwise direction, and in which multiple intersecting slits 5 are formed with penetrating cuts in the single article slit 4. The 1st felt 6 has the function of maintaining the disk, and may make use of a conventional felt in its existent state. The intersecting slit 5 is a felt which is prevented from becoming too hard, and through which a disk 1 can be easily passed. In the figure, 7 represents a 2nd felt in which a single article slit 4 containing at least one cut passes through, formed in the lengthwise direction, and which has elasticity which is weaker than that of the 1st felt 6. The 2nd felt 7 serves to support the function of maintaining the disk. In the figure, 9 represents a vinyl chloride surface sheet in which is formed a disk transmitting aperture 8, and which has the function of maintaining the felt. In the figure, 12 is a position determining hole for inserting a protrusion formed in the periphery of the gate 2 of gate member 11. The fixation method of each of the components, may include the free use of adhesives, sticky adhesions, two sided sticky tape 13, and others. However, in the present Embodiment, use is made of two sided sticky tape 13. By fixedly adhering the 1st felt 6 to the rear surface of the surface sheet 9, the 2nd felt 7 is fixedly adhered to the rear surface of the 1st felt 6, completing the position determining opening 12, by fixedly adhering the gate member 11 and the 2nd felt 7, and inserting a protrusion formed in the periphery of gate 2 of gate member 11, and accurate positioning can be accomplished of the gate construction. The slanted line shown in FIG. 4 and FIG. 7 is a sticky region onto which the two sided sticky tape is glued.

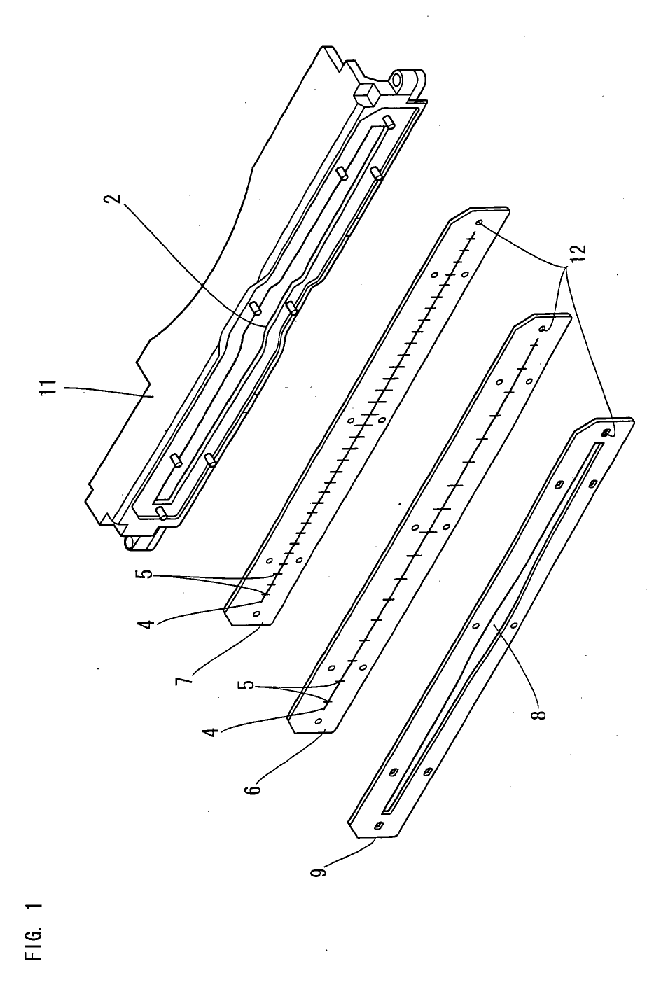

The 2nd felt 7 of the gate construction of FIG. 1 has twice as many intersecting slits 5 as do the single article slit 4 and the 1st felt 6. If the intersecting slits 5 are increased, and the spacing is made shorter, then the 2nd felt 7 does not change overall. However, the elasticity and hardness of the individual cuts made by the intersecting slit 9 become smaller.

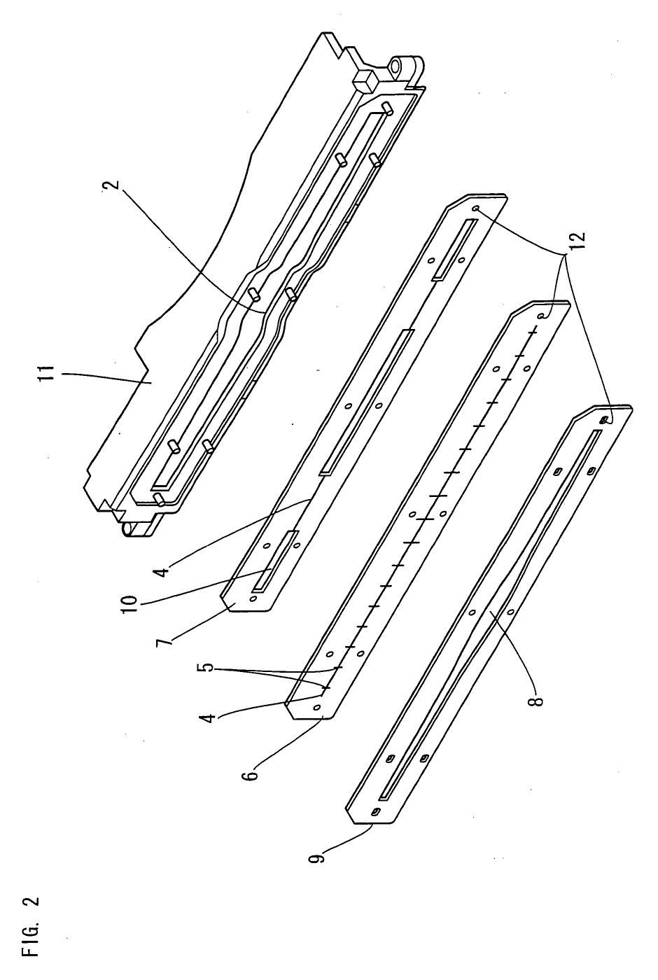

The 2nd felt 7 of the gate construction shown in FIG. 2 has cutouts formed in three locations on a felt in which is formed a single article slit 4. If cutouts 10 are formed, then elasticity and hardness is reduced.

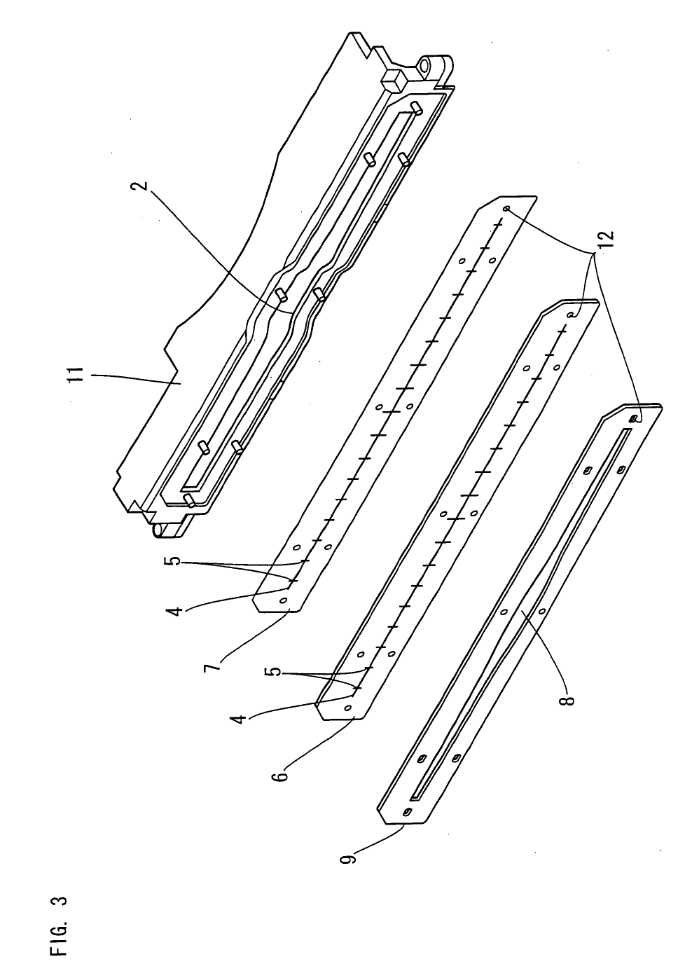

The 2nd felt 7 of the gate construction of FIG. 3, has a fore and aft thickness which is thinner than that of the 1st felt 6, and the same number of intersecting slits 5 are formed as in the single article slit 4 and the 1st felt 6. If the felt is thin, then the overall elasticity and hardness of the 2nd felt 7 becomes small.

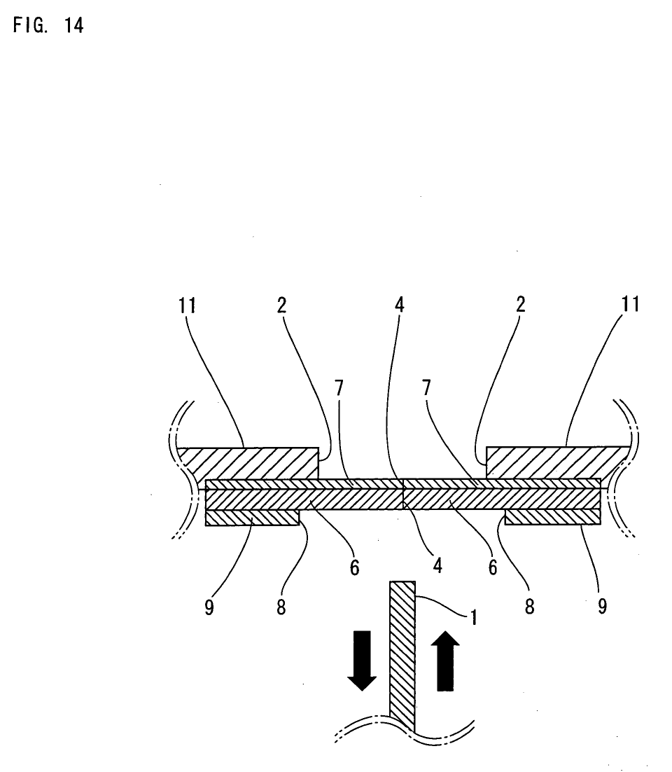

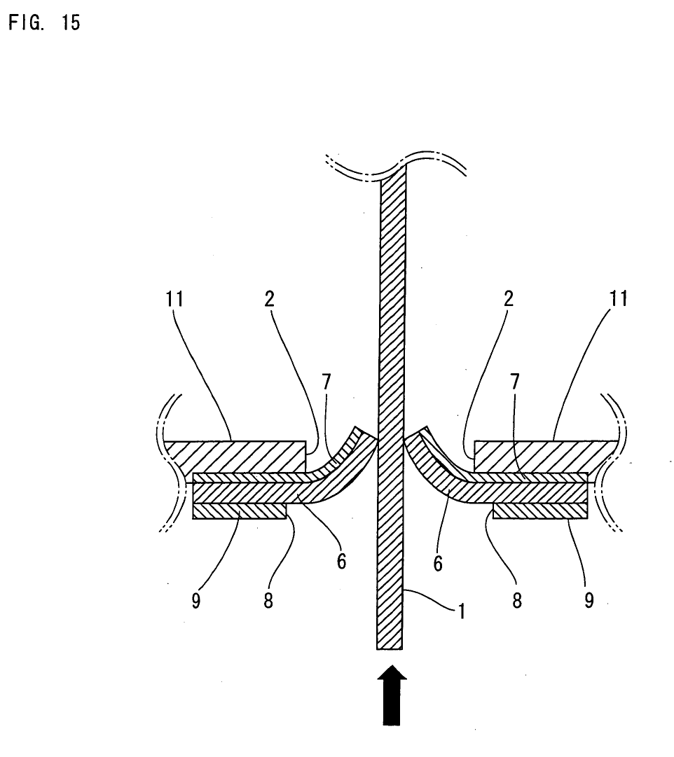

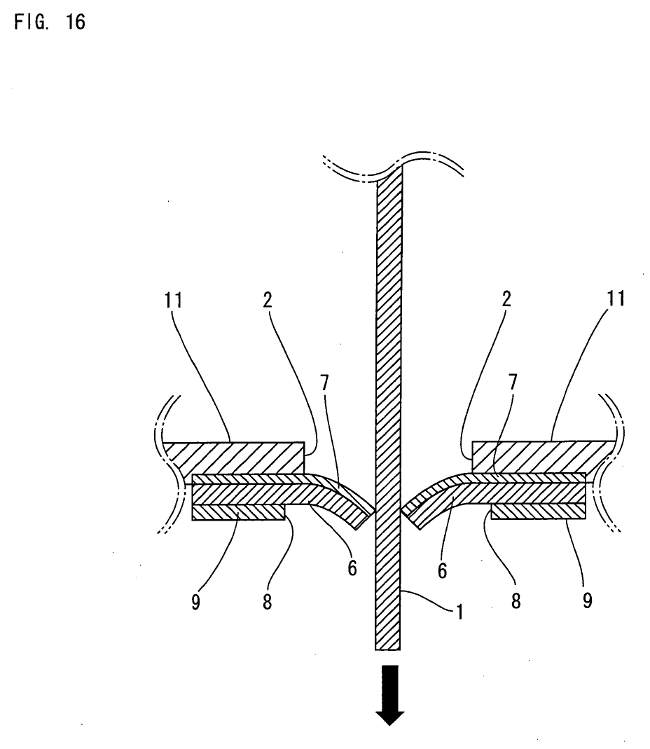

FIG. 14, FIG. 15, and FIG. 16 show the disk maintenance state when inserting and withdrawing the disk 1 to and from the disk device 3. In the Embodiment shown in the drawings, the 2nd felt 7 uses a felt thickness which is thinner than that of the 1st felt 6. The ordinary single article slit 4 is closed from both sides, as shown in FIG. 14. First of all, the user, as shown in FIG. 14 moves the disk 1 toward and facing a single article slit 4. As shown by the state shown in FIG. 15, the disk 1 is inserted until it reaches the transport in the position of the slot-in mechanism from the single article slit 4, and releasing the hand, the disk 1 freely inserts into the transport a in disk device 3. By inserting the disk 1, the single article slit 4 is internally pushed open on both sides, in an elastically formed state, the disk 1 being maintained and interposed in both directions, maintaining the elastic restorative force generated at the time. By making the 1st felt 6 and the 2nd felt 7 to fixedly adhere in a double layer, the disk 1 is held with strong force produced by the strengthened elasticity. Lastly, the user withdraws the disk 1 shown in FIG. 14 from the disk device 3.

The 2nd felt 7 may also form a single slit 4 and a cut-out 10 in a felt in which the fore and after thickness is thinner than that of the 1st felt 6. The 2nd felt 7 may form a single article slit 4 and multiple intersecting slits 5 in a felt in which the fore and after thickness is thinner than that of the 1st felt 6. The 2nd felt 7 may also form a single article slit 4, intersecting slits 5 and a cut-out 10, in which use may be made of a felt which is thinner than that of the 1st felt 6. Gate construction may also be used in which use is not made of a surface sheet 9. A surface sheet 9 or a 1st felt 6 may be fixedly adhered to the rear surface of gate 2 rather than to the front surface. In making the disk support force of the 2nd felt 7 to be weaker than that of the 1st felt 6, it is not necessary to restrict it to the methods described above, but use may be made of any method.

1. Gate construction in a disk device having a slot-in format comprising a gate which inserts a disk into and withdraws the disk from a device, wherein the gate is provided with an elastically formed 1st felt provided with a single article slit, and multiple intersecting slits; and a 2nd felt which is fixedly adhered to the rear surface of the 1st felt on which is formed at least a single article slit, the elasticity of the 2nd felt being weaker than that of the 1st felt.

2. Gate construction in a disk device having a slot-in format, comprising a gate which inserts a disk into and withdraws the disk from a device, wherein the gate is provided with an elastically formed 1st felt which is fixedly adhered to the rear surface of a surface sheet on which is formed a single article slit and multiple intersecting slits, and a 2nd felt which is fixedly adhered to the rear surface of the 1st felt on which is formed at least a single article slit, the elasticity of the 2nd felt being weaker than that of the 1st felt.

3. Gate construction in the disk device of the slot-in format of claim wherein the multiple intersecting slits are formed in a greater number of in the 2nd felt than in the 1st felt.

4. Gate construction in the disk device of the slot-in format of claim 1, wherein the multiple cutouts are formed in the single article slit of the 2nd felt.

5. Gate construction in the disk device of the slot-in format of claim 1, wherein the thickness before and after the 2nd felt is thinner than in the 1st felt.

6. Gate construction in the disk device of the slot-in format of claim 2, wherein the multiple intersecting slits are formed in a greater number of in the 2nd felt than in the 1st felt.

7. Gate construction in the disk device of the slot-in format of claim 2, wherein the multiple cutouts are formed in the single article slit of the 2nd felt.

8. Gate construction in the disk device of the slot-in format of claim 3, wherein the multiple cutouts are formed in the single article slit of the 2nd felt.

9. Gate construction in the disk device of the slot-in format of claim 2, wherein the thickness before and after the 2nd felt is thinner than in the 1st felt.

10. Gate construction in the disk device of the slot-in format of claim 3, wherein the thickness before and after the 2nd felt is thinner than in the 1st felt.

11. Gate construction in the disk device of the slot-in format of claim 4, wherein the thickness before and after the 2nd felt is thinner than in the 1st felt.
